(19) United States
(12) Patent Application Publication
(10) Pub. No.: US 2026/0186339 A1
(43) Pub. Date: Jul. 2, 2026

(54) BACKLIGHT MODULE, DISPLAY DEVICE, AND DRIVING METHOD FOR DISPLAY DEVICE

(71) Applicants: HEFEI BOE OPTOELECTRONICS TECHNOLOGY CO., LTD., Hefei, Anhui (CN); BOE TECHNOLOGY GROUP CO., LTD., Beijing (CN); BEIJING BOE TECHNOLOGY DEVELOPMENT CO., LTD., Beijing (CN)

(72) Inventors: Zhao DONG, Beijing (CN); Xuemei ZHAO, Beijing (CN); Bangmin CHEN, Beijing (CN); Douqing ZHANG, Beijing (CN); Hu LI, Beijing (CN)

(21) Appl. No.: 18/834,196

(22) PCT Filed: Apr. 28, 2023
(86) PCT No.: PCT/CN2023/091541

§ 371 Date: Jul. 29, 2024

(51) Int. Cl. G02F 1/13357; G02F 1/1335; G09G 3/34

(52) U.S. Cl. CPC G02F 1/133603; G02F 1/133611; G02F 1/133612; G09G 3/3426; G09G 2320/0233

(57) ABSTRACT

A backlight module, a display device, and a driving method for the display device are provided. The backlight module includes: a substrate including light-emitting areas. The light-emitting areas include first light-emitting areas located in the peripheral region and second light-emitting areas located in the central region. Each light-emitting area include light-emitting units. The light-emitting units in each of the first light-emitting areas include first light-emitting units corresponding one-to-one with the light-emitting units in the second light-emitting area. The centers of the first light-emitting units in the first light-emitting area are located at the vertices of a first polygon, while the centers of the light-emitting units in the second light-emitting area are located at the vertices of a second polygon. The first polygon and the second polygon are similar polygons. The plurality of light-emitting units of at least one first light-emitting area further include a second light-emitting units.

### TECHNICAL FIELD

Embodiments of the disclosure relate to a backlight module, a display device, and a driving method for the display device.

### BACKGROUND

In recent years, with the development of the MLED industry, the application of MLED backlight sources has become increasingly widespread. MLED includes Mini-LED (typically ranging in size from 50 μm to 300 μm) and Micro-LED (typically smaller than 50 μm). The LED chips used in MLED backlight are much smaller in size compared to those used in the traditional backlight. This allows for more precise control of the backlight, which can improve the contrast and color accuracy of the display.

A MLED backlight consists of a large number of tiny LED chips arranged in a matrix. Each LED chip or chip group containing multiple LED chips can be individually controlled, making the control of the backlight more precise than the traditional LED backlight. Because the backlight can be dimmed in areas of the screen that should be dark, higher contrast can be achieved. Additionally, this type of backlight can be adjusted to produce the correct color temperature for each scene, further improving the color accuracy of the display.

### SUMMARY

Embodiments of the disclosure provide a backlight module, a display device and a driving method for the display device.

At least one embodiment of the disclosure provides a backlight module comprising: a substrate including an array region in which a plurality of light-emitting areas are arranged in an array, wherein the array region comprises a peripheral area and a central area located inside the peripheral area, the plurality of light-emitting areas comprise a plurality of first light-emitting areas located in the peripheral area and a plurality of second light-emitting areas located in the central area, each of the first light-emitting areas and each of the second light-emitting areas comprise a plurality of light-emitting units, numbers of the light-emitting units in at least two second light-emitting areas of the plurality of second light-emitting areas are equal, the plurality of light-emitting units in each of the first light-emitting areas comprise a plurality of first light-emitting units corresponding one-to-one with the plurality of light-emitting units in each of the at least two second light-emitting areas, centers of the plurality of first light-emitting units in each of the first light-emitting areas are located at respective vertices of a first polygon, and centers of the plurality of light-emitting units in each of the at least two second light-emitting areas are located at respective vertices of a second polygon, the first polygon and the second polygon are similar polygons, and the plurality of light-emitting units of at least one of the plurality of first light-emitting areas further include a second light-emitting unit.

In the backlight module according to some examples of the disclosure, dimensions and a shape of the first polygon are identical to those of the second polygon.

In the backlight module according to some examples of the disclosure, a side length of the first polygon is less than a corresponding side length of the second polygon.

In the backlight module according to some examples of the disclosure, the second light-emitting unit is located inside the first polygon.

In the backlight module according to some examples of the disclosure, a distance between a center of the second light-emitting unit and a geometric center of the first polygon is less than one-fifth of a shortest side length of the first polygon.

In the backlight module according to some examples of the disclosure, the center of the second light-emitting unit is located at the geometric center of the first polygon.

In the backlight module according to some examples of the disclosure, the second light-emitting unit is serially connected to the plurality of first light-emitting units.

The backlight module according to some examples of the disclosure further comprises: conductive wires located on the substrate and serially connecting the second light-emitting unit and the plurality of first light-emitting units, wherein the conductive wires are symmetrically distributed relative to a straight line passing through a center of the second light-emitting unit.

In the backlight module according to some examples of the disclosure, the second light-emitting unit has a strip shape extending along a first direction parallel to the substrate, and the straight line extends along a second direction perpendicular to the first direction and parallel to the substrate.

In the backlight module according to some examples of the disclosure, the second light-emitting unit is located outside the first polygon.

In the backlight module according to some examples of the disclosure, the second light-emitting unit is located on a side of the plurality of first light-emitting units away from the second light-emitting areas.

In the backlight module according to some examples of the disclosure, at least one of the plurality of first light-emitting areas having the second light-emitting unit is located at a corner position of the array region, wherein the plurality of first light-emitting units in the first light-emitting area comprise a corner light-emitting unit closest to the corner position, and the second light-emitting unit comprises a first edge light-emitting unit located at a side of the corner light-emitting unit away from a center of the array region.

In the backlight module according to some examples of the disclosure, the first edge light-emitting unit is serially connected to the plurality of first light-emitting units, and in a serial circuit of the first edge light-emitting unit and the plurality of first light-emitting units, the first edge light-emitting unit is positioned between the plurality of first light-emitting units.

In the backlight module according to some examples of the disclosure, numbers of first light-emitting units on each side of the first edge light-emitting unit in the serial circuit are equal.

In the backlight module according to some examples of the disclosure, a distance between a center of the first edge light-emitting unit and a center of the corner light-emitting unit in the first light-emitting area is less than a distance between centers of any two adjacent first light-emitting units in the first light-emitting area.

In the backlight module according to some examples of the disclosure, the first polygon includes a first side and a second side closest to a corner position of the array region, and an end of the first side is connected to an end of the second side, the second light-emitting unit comprise a second edge light-emitting unit located on a side of the first side away from the inside of the array region and a third edge light-emitting unit located on a side of the second side away from the inside of the array region.

In the backlight module according to some examples of the disclosure, the second edge light-emitting unit and the third edge light-emitting unit are serially connected to one first light-emitting unit of the first light-emitting units to form a first serial circuit, and the one first light-emitting unit serially connected to the second light-emitting units is the first light-emitting unit closest to the third edge light-emitting unit except for the corner light-emitting unit, the remaining first light-emitting units in the plurality of first light-emitting areas are sequentially connected in series to form a second serial circuit, and both ends of the first serial circuit and the second serial circuit are connected to each other to form a parallel circuit.

In the backlight module according to some examples of the disclosure, the numbers of light-emitting units in the first serial circuit and the second serial circuit are equal.

In the backlight module according to some examples of the disclosure, the first light-emitting area is located at a corner position of the array region, and the first light-emitting units in the first light-emitting area includes a corner light-emitting unit closest to the corner position of the array region, the second light-emitting unit includes a first edge light-emitting unit located at a side of the corner light-emitting unit away from the center of the array region, the first polygon includes a first side and a second side closest to the corner position of the array region, and an end of the first side is connected to an end of the second side, and the second light-emitting unit includes a second edge light-emitting unit located on a side of the first side away from the inside of the array region and a third edge light-emitting unit located on a side of the second side away from the inside of the array region.

In the backlight module according to some examples of the disclosure, the second edge light-emitting unit, the first edge light-emitting unit, and the third edge light-emitting unit are sequentially connected in series to form a first series circuit, and the plurality of first light-emitting units are connected in series to form a second series circuit, and both ends of the first series circuit and the second series circuit are connected to each other to form a parallel circuit.

In the backlight module according to some examples of the disclosure, the second edge light-emitting unit, the first edge light-emitting unit, the third edge light-emitting unit, and one first light-emitting unit of the first light-emitting units are sequentially connected in series to form a first series circuit, and the one first light-emitting units connected in series with the plurality of second light-emitting units is one first light-emitting unit closest to the third edge light-emitting unit except for the corner light-emitting unit, and the remaining first light-emitting units in the plurality of first light-emitting units are sequentially connected in series to form a second series circuit, and both ends of the first series circuit and the second series circuit are connected to each other to form a parallel circuit.

In the backlight module according to some examples of the disclosure, a line connecting centers of the first edge light-emitting unit and the second edge light-emitting unit is parallel to the first side, and a distance from the center of the second edge light-emitting unit to the first side is from ⅓ to \sqrt{3}/2 of a length of the first side.

In the backlight module according to some examples of the disclosure, a line connecting centers of the first edge light-emitting unit and the third edge light-emitting unit is parallel to the second side, and a distance from the center of the third edge light-emitting unit to the second side is from ⅓ to \sqrt{3}/2 of a length of the second side.

In the backlight module according to some examples of the disclosure, a ratio of a side length of the first polygon to a corresponding side length of the second polygon is greater than or equal to ⅔ and less than 1.

In the backlight module according to some examples of the disclosure, an orthographic projection of the second edge light-emitting unit on a straight line where the first side of the first polygon is located overlaps with at least a portion of the first side, and an orthographic projection of the third edge light-emitting unit on a straight line where the second side of the first polygon is located overlaps with at least a portion of the second side.

In the backlight module according to some examples of the disclosure, a perpendicular bisector of the first side passes through the second edge light-emitting unit, and a perpendicular bisector of the second side passes through the third edge light-emitting unit.

In the backlight module according to some examples of the disclosure, an extension line of the second side towards the outside of the array region passes through the second edge light-emitting unit, and an extension line of the first side towards the outside of the array region passes through the third edge light-emitting unit.

In the backlight module according to some examples of the disclosure, the first polygon and the second polygon both have a rectangular shape.

In the backlight module according to some examples of the disclosure, the plurality of light-emitting units are all strip-shaped and extend along a first direction, wherein the first direction is parallel to the long side of the rectangular shape.

In the backlight module according to some examples of the disclosure, each light-emitting area includes a first terminal and a second terminal to provide a driving power supply to the plurality of light-emitting units in the light-emitting area, and each light-emitting area is configured to be independently driven.

In the backlight module according to some examples of the disclosure, the array region includes a plurality of driving regions, and the light-emitting areas in each driving region are connected to a driver located on a side of the array region.

In the backlight module according to some examples of the disclosure, each driving region includes a plurality of sub-driving regions, each sub-driving region includes a plurality of light-emitting areas arranged along a row direction and a column direction, and the first terminals of the plurality of light-emitting units in each sub-driving region are connected to a same first power line, and the first terminals of the plurality of light-emitting units in different sub-driving regions are connected to different first power lines.

In the backlight module according to some examples of the disclosure, the second terminals of the plurality of light-emitting units in the same sub-driving region are respectively connected to different second power lines, and the light-emitting areas located in different sub-driving regions and in the same column comprise the light-emitting areas connected to a same second power line.

In the backlight module according to some examples of the disclosure, in different sub-driving regions of the same driving region, the light-emitting areas in two sub-driving regions and in the same column correspond one-to-one with each other, and the second terminals of the light-emitting areas corresponding with each other are connected to the same second power line.

In the backlight module according to some examples of the disclosure, at least some of the plurality of light-emitting units are surrounded by reflection structures, and the reflection structures form recesses corresponding to the light-emitting units, and the light-emitting units are placed in the recesses.

At least one embodiment of the disclosure provides a backlight module comprising: a substrate including an array region, the array region including a plurality of light-emitting areas arranged in an array, wherein the array region includes a peripheral area and a central area located inside the peripheral area, and the plurality of light-emitting areas include a plurality of first light-emitting areas located in the peripheral area and a plurality of second light-emitting areas located in the central area, and each first light-emitting area and each second light-emitting area include a plurality of light-emitting units, each first light-emitting area and each second light-emitting area have the same number and arrangement of light-emitting units, in a case where a same power signal is input, light intensity of the light-emitting units in at least one first light-emitting area of the first light-emitting areas is greater than that of the light-emitting units in the second light-emitting area.

In the backlight module according to some examples of the disclosure, the array region has a plane shape including a polygon, and the at least one first light-emitting area is located at at least one corner of the array region.

At least one embodiment of the disclosure provides a display device comprising a backlight module according to any one of the above-mentioned embodiments.

At least one embodiment of the disclosure provides a driving method for a display device, wherein the display device comprises a backlight module and a liquid crystal display panel stacked on each other, wherein the backlight module comprises an array region, and the array region includes a plurality of light-emitting areas independently driven and arranged in an array, the array region includes a peripheral area and a central area located inside the peripheral area, and the plurality of light-emitting areas include a plurality of first light-emitting areas located in the peripheral area and a plurality of second light-emitting areas located in the central region, and the liquid crystal display panel comprises a plurality of sub-display areas, the sub-display areas include a plurality of first sub-display areas corresponding one-to-one with the plurality of first light-emitting areas and a plurality of second sub-display areas corresponding one-to-one with the plurality of second light-emitting areas, the method comprises: driving the plurality of light-emitting areas to emit light and driving transmittance of the plurality of sub-display areas to display images, wherein the plurality of first light-emitting areas and the plurality of second light-emitting areas are driven to emit light such that a ratio of light intensity emitted by at least one first light-emitting area in the plurality of first light-emitting areas to a grayscale value to be displayed by a corresponding first sub-display area is greater than a ratio of light intensity emitted by the second light-emitting area to a grayscale value to be displayed by a corresponding second sub-display area; and/or the plurality of first sub-display areas and the plurality of second sub-display areas are driven to display such that a ratio of transmittance of at least one first sub-display area in the plurality of first sub-display areas to a grayscale value to be displayed by the first sub-display area is greater than a ratio of transmittance of the second sub-display area to a grayscale value to be displayed by the second sub-display area.

### BRIEF DESCRIPTION OF DRAWINGS

To provide a clearer explanation of the technical solutions of the embodiments disclosed herein, a brief introduction to the drawings of the embodiments is presented below. It is evident that the drawings described below only relate to some embodiments disclosed herein, and not to limitations of the disclosure.

FIG. 1 illustrates a schematic diagram of the brightness distribution of a backlight unit.

FIGS. 2A and 2B illustrate schematic diagrams of the planar structure of backlight module according to some embodiments of the disclosure.

FIG. 3 illustrate a schematic diagram of the planar structure of a backlight module according to other embodiments of the disclosure.

FIG. 4 illustrates an arrangement and connection schematic diagram of light-emitting units within a light-emitting area according to an embodiment of the disclosure.

FIG. 5 illustrates an arrangement and connection schematic diagram of light-emitting units within a light-emitting area according to an embodiment of the disclosure.

FIG. 6 illustrates an arrangement and connection schematic diagram of light-emitting units within a light-emitting area according to an embodiment of the disclosure.

FIG. 7 illustrates an arrangement and connection schematic diagram of light-emitting units within a light-emitting area according to an embodiment of the disclosure.

FIG. 8 illustrates an arrangement and connection schematic diagram of light-emitting units within a light-emitting area according to an embodiment of the disclosure.

FIG. 9 illustrates an arrangement and connection schematic diagram of light-emitting units within a light-emitting area according to an embodiment of the disclosure.

FIG. 10 illustrates an arrangement and connection schematic diagram of light-emitting units within a light-emitting area according to an embodiment of the disclosure.

FIG. 11 illustrates a wiring structure schematic diagram for driving light-emitting units in the light-emitting areas according to some embodiments of the disclosure.

FIG. 12 illustrates a local wiring structure schematic diagram for a backlight module including a light-emitting area with a second light-emitting unit according to embodiments of the disclosure.

FIG. 13 illustrates a schematic diagram of the planar structure of a backlight module according to an embodiment of the disclosure.

FIG. 14 illustrates a local schematic diagram of the planar structure of a backlight module according to an embodiment of the disclosure.

FIG. 15 illustrates a local schematic diagram of the cross-sectional structure of a backlight module according to an embodiment of the disclosure.

FIG. 16 illustrates a schematic diagram of driving signals for modulation without distinguishing between peripheral and internal light-emitting areas.

FIG. 17 illustrates a schematic diagram of driving signals for modulation distinguishing between peripheral and internal light-emitting areas.

### DETAILED DESCRIPTION

In order to clarify the purpose, technical solutions, and advantages of embodiments of the disclosure, the technical solutions of the embodiments of the disclosure will be described clearly and comprehensively in conjunction with the drawings of the embodiments of the disclosure. Clearly, the described embodiments are part of the embodiments of the disclosure, not all embodiments. Based on the described embodiments of the disclosure, all other embodiments obtained by those skilled in the art in the field of the disclosure without the need for inventive labor belong to the scope of protection of the disclosure.

Unless otherwise defined, technical terms or scientific terms used in the disclosure should be understood in the ordinary sense by those skilled in the art to which the disclosure belongs. The terms “first,” “second,” and similar words used in the disclosure do not indicate any order, quantity, or importance, but are merely used to distinguish different components. Phrases such as “comprising” or “including” imply that the elements or objects appearing before the term cover the elements or objects listed after the term and their equivalents, without excluding other elements or objects. Terms such as “connected” or “coupled” are not limited to physical or mechanical connections but may include electrical connections, whether direct or indirect. Words such as “up,” “down,” “left,” “right,” etc., only indicate relative positional relationships, and when the absolute position of the object being described changes, the relative positional relationship will correspondingly change.

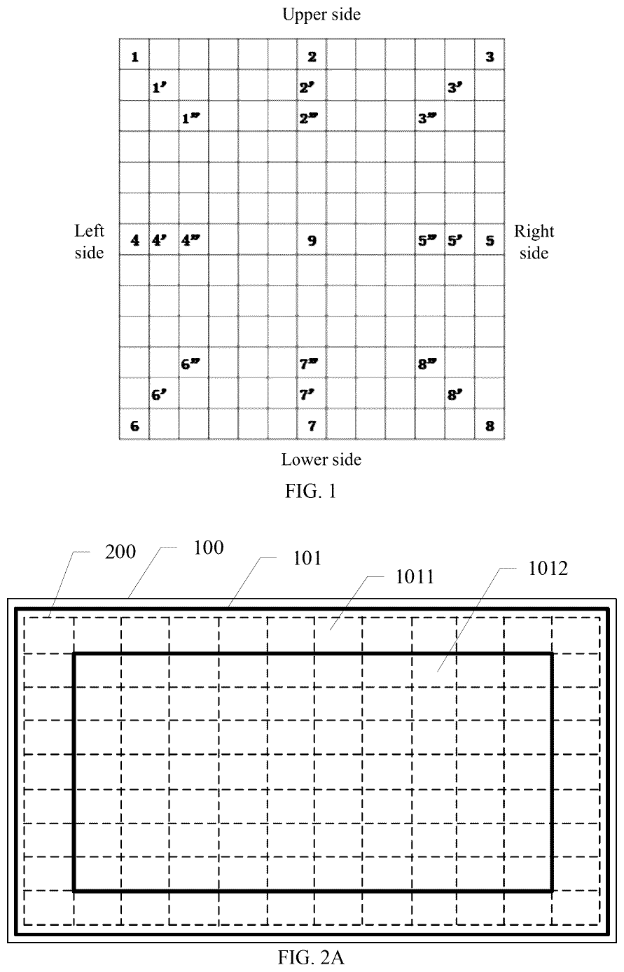

The uniformity of full-screen brightness of a MLED backlight has a significant impact on the display quality of the display device. Additionally, when a MLED backlight is paired with HDR (High-Dynamic Range) technology, it can enhance image brightness and contrast. HDR can brighten details in dark areas, make dark areas darker, and enrich more detail colors, resulting in excellent performance for movies and images. When testing the full-screen brightness uniformity of a display screen using HDR backlight, the full-screen brightness uniformity (brightness uniformity=minimum brightness/maximum brightness) is only 50%. When excluding the four corner points, the brightness uniformity improves to 75%. The main reason for darkening at the corner positions is mainly due to the halo effect of MLED. As shown in FIG. 1, the display screen is divided into several light-emitting areas arranged in matrix. Due to the halo effect, for light-emitting areas located internally, other light-emitting areas around the light-emitting area can have an auxiliary effect on the brightness generated by the light-emitting area. For the four corner positions, such as light-emitting areas 1, 3, 6, and 8 shown in FIG. 1, they lack the halo effect of the external ¾ area; for the light-emitting areas at the four edges, such as light-emitting areas 2, 4, 5, and 7 shown in FIG. 1, they lack the halo effect of the external ½ area. In addition, in some light-emitting areas outside this periphery, the brightness generated may also be lower than that of the light-emitting areas in the internal region due to the halo effect, but the difference in brightness between them and the light-emitting areas in the internal region is smaller than the difference in brightness between the light-emitting areas located at the corners and edges mentioned above and the light-emitting areas in the internal region. As shown in FIG. 1 schematically, for the positions near the corner, the light-emitting area 1 has a lower brightness than the light-emitting area 1′, and the light-emitting area 1′ has a lower brightness than the light-emitting area 1″. For the positions near the edge, the light-emitting area 2 has a lower brightness than the light-emitting area 2′, and the light-emitting area 2′ has a lower brightness than the light-emitting area 2″. Similarly, for other light-emitting areas near the corners and edges, their brightness follows a similar changing pattern. Of course, here, the brightness comparison is based on the same driving conditions. For example, the above comparison compares the brightness of each light-emitting area under the same driving current and voltage for a white image. For example, the decrease in brightness of these edge or corner light-emitting areas generally affects the outer three layers of light-emitting areas arranged in an array, but the most affected are still the light-emitting areas at the edges and corners.

According to an embodiment of the disclosure, a backlight module is provided. The backlight module comprises: a substrate including an array region, wherein a plurality of light-emitting areas arranged in an array are disposed within the array region. The array region includes a peripheral area and a central area located inside the peripheral area. The plurality of light-emitting areas include a plurality of first light-emitting areas located in the peripheral area and a plurality of second light-emitting areas located in the central area. Each first light-emitting area and each second light-emitting area include a plurality of light-emitting units. Each second light-emitting area of the plurality of second light-emitting areas has the same number of light-emitting units. Although here the number of light-emitting units set in each second light-emitting area is equal, embodiments of the disclosure are not limited thereto. For example, it can be the case that the number of light-emitting units set in at least two second light-emitting areas is equal. The plurality of light-emitting units in the first light-emitting area include the plurality of first light-emitting units corresponding one-to-one with the plurality of light-emitting units in the second light-emitting area (e.g., the second light-emitting area with an equal number of light-emitting units). The centers of the plurality of first light-emitting units in the first light-emitting area are located at the vertices of a first polygon, and the centers of the light-emitting units in the second light-emitting area (e.g., the second light-emitting area with an equal number of light-emitting units) are located at the vertices of a second polygon, wherein the first polygon and the second polygon are similar shapes. Furthermore, the plurality of light-emitting units in at least one first light-emitting area among the plurality of first light-emitting areas include a second light-emitting unit. In the backlight module according to the embodiment of the disclosure, at least one first light-emitting area located in the peripheral area of the array region further includes a second light-emitting unit, so the number of light-emitting units it contains is greater than the number of light-emitting units in the second light-emitting area, thereby compensating for the darkening of the peripheral area due to the halo effect. Additionally, due to the correspondence between the first light-emitting units in the first light-emitting area and the light-emitting units in the second light-emitting area, where the geometric shapes formed by lines connecting the centers of them are similar shapes, the backlight module according to the embodiment of the disclosure can prevent excessive changes in wiring circuits or wiring patterns used to drive the light-emitting units in the peripheral area caused by the addition of the second light-emitting unit. Therefore, embodiments of the disclosure can improve brightness issues in the peripheral light-emitting areas while maintaining compatibility with other designs.

For example, in some embodiments of the disclosure, a plurality of first light-emitting areas each comprise a plurality of light-emitting units that correspond one-to-one with a plurality of light-emitting units in the second light-emitting area. Here, “correspond one-to-one” can refer to each light-emitting unit in the second light-emitting area having a corresponding first light-emitting unit in the first light-emitting area. Therefore, the number of first light-emitting units in each first light-emitting area is the same as the number of light-emitting units in each second light-emitting area. Combined with the aforementioned first polygon and second polygon being similar shapes, this makes the basic architecture of light-emitting units in the first light-emitting area and the second light-emitting area similar, thereby preventing excessive changes in wiring circuits or wiring patterns used to drive the light-emitting units in the first light-emitting area due to the addition of the second light-emitting unit. For example, the first light-emitting area includes four first light-emitting units located at the four corners of a rectangle, and the second light-emitting area also includes four light-emitting units located at the four corners of a rectangle. However, embodiments of the disclosure do not particularly limit the shapes of the first polygon and the second polygon.

According to some embodiments of the disclosure, a backlight module is further provided, comprising: a substrate including an array region, wherein a plurality of light-emitting areas arranged in an array are disposed within the array region. The array region includes a peripheral area and a central area located inside the peripheral area. The plurality of light-emitting areas include a plurality of first light-emitting areas located in the peripheral area and a plurality of second light-emitting areas located in the central area, each first light-emitting area and each second light-emitting area including multiple light-emitting units. Each first light-emitting area and each second light-emitting area is equal, and the arrangement have the same number of light-emitting units. Under the condition of inputting the same power signal, the light intensity emitted by the light-emitting units in at least one first light-emitting unit of the first light-emitting areas is greater than the light intensity emitted by the light-emitting units in the second light-emitting area. In the backlight module according to these embodiments of the disclosure, light-emitting areas in both the peripheral area and the central area adopt light-emitting units with the same arrangement and the same number, but light-emitting units with higher brightness levels can be used in the peripheral area. Since the manufacturers of light-emitting units already have multiple brightness levels for products of the same specifications, using light-emitting units with different brightness levels distributed in different areas improves the brightness uniformity of the backlight module without changing the original circuit layout design, thereby improving the brightness issues of light-emitting areas in the peripheral area without significantly increasing costs.

According to another embodiment of the disclosure, a method for driving a display device is provided. The display device includes a backlight module and a liquid crystal display panel stacked on each other. The backlight module comprises an array region in which a plurality of light-emitting areas are arranged in an array and independently driven. The array region includes a peripheral area and a central area located inside the peripheral area. The plurality of light-emitting areas include a plurality of first light-emitting areas located in the peripheral area and a plurality of second light-emitting areas located in the central area. The liquid crystal display panel includes a plurality of sub-display areas, and the plurality of sub-display areas include a plurality of first sub-display areas corresponding one-to-one with the plurality of first light-emitting areas and a plurality of second sub-display areas corresponding one-to-one with the plurality of second light-emitting areas. The method comprises: driving the plurality of light-emitting areas to emit light and driving the transmittance of the plurality of sub-display areas to display images. The plurality of first light-emitting areas and the plurality of second light-emitting areas are driven to emit light such that the ratio of the light intensity emitted by at least one of the plurality of first light-emitting areas to the grayscale value to be displayed in the corresponding first sub-display area is greater than the ratio of the light intensity emitted by the second light-emitting area to the grayscale value to be displayed in the corresponding second sub-display area; and/or the plurality of first sub-display areas and the plurality of second sub-display areas are driven to display such that the ratio of the transmittance of at least one first sub-display area to the grayscale value to be displayed in that first sub-display area is greater than the ratio of the transmittance of the second sub-display area to the grayscale value to be displayed in the second sub-display area. These embodiments of the disclosure improve the brightness of the light-emitting areas in the peripheral region of the backlight module from the perspective of the product's driving method without altering the product's structural design or incurring additional costs.

Hereinafter, a more detailed description of the backlight module, display device, and the driving method of the display device is provided in conjunction with some exemplary embodiments of the disclosure. This will provide a clearer understanding of the technical solutions according to the disclosure.

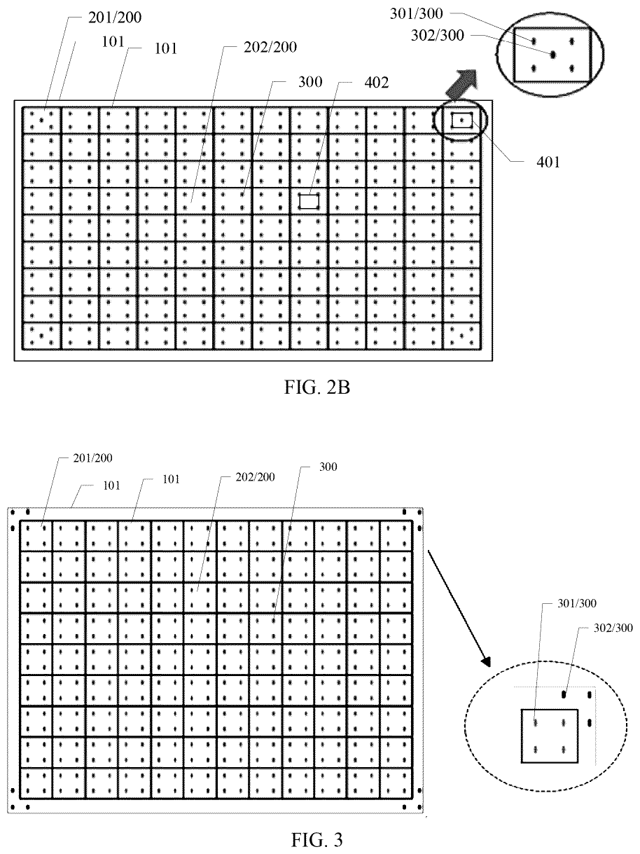

FIG. 2 illustrates a schematic diagram of the planar structure of the backlight module according to some embodiments of the disclosure. As shown in FIG. 2, the backlight module according to the embodiment comprises a substrate 100. The substrate 100 includes an array region 101. For example, the array region 101 can occupy a majority of the planar area of the substrate 100, effectively utilizing most of the substrate's planar area. The distances between the edges of the array region 101 and the edges of the substrate are not specifically limited and can be arbitrarily set according to practical needs. Here, the array region 101 is the region where the light-emitting areas are arranged in an array and can also be referred to as the effective area of the substrate of the backlight module. To achieve the goal of narrow bezels, the peripheral area of the substrate located around the array region 101 can be minimized as much as possible. Necessary wiring and other components can be arranged in the peripheral area around the array region 101 (i.e., the area outside the array region 101 or the area around the array region 101). The embodiment shown in FIG. 2 depicts the substrate 100 and the array region 101 as generally rectangular in shape. However, embodiments of the disclosure are not limited to this, and the planar shapes of the substrate 100 and the array region 101 can be adjusted as needed. For instance, they can be tailored according to the shape of the display panel where this backlight module will be applied. In some cases, display panels with irregular shapes may require corresponding shaped backlight modules. Additionally, the planar shape of the array region 101 may differ from that of the substrate 100.

As shown in FIG. 2A and FIG. 2B, the substrate 100 includes an array region 101. The array region 101 is provided with a plurality of light-emitting areas 200 arranged in an array. For example, the rectangular structures arranged in an array in FIG. 2A and FIG. 2B represent the light-emitting areas 200, and in FIG. 2A, the rectangular structures representing the light-emitting areas 200 are depicted as dashed-line frames to clearly show the positional relationship with other areas. FIGS. 2A and 2B depict an array arrangement of 9 rows and 12 columns of light-emitting areas 200, but this is merely exemplary. The light-emitting areas 200 of the backlight module according to the embodiment of the disclosure can have more or fewer light-emitting areas 200. The array region 101 comprises a peripheral area 1011 and a central area 1012 located inside the peripheral area 1011. As shown in FIG. 2A, the central area 1012 refers to the area enclosed by the small solid-line frame, while the peripheral area 1011 refers to the area between the large solid-line frame and the small solid-line frame. For example, the light-emitting areas 200 in the peripheral area can include one ring (including row or column) or a plurality of rings (multiple rows and columns) of light-emitting areas. For instance, when the first light-emitting area 201 includes one ring of light-emitting areas, it represents the outermost ring of light-emitting areas; when the first light-emitting area 201 includes two rings of light-emitting areas, it represents the outermost two rings of light-emitting areas. The example shown in FIG. 2A illustrates the setting of one ring of light-emitting areas in the peripheral area, but embodiments of the disclosure are not limited to this. For example, the width of the peripheral area (i.e., the number of rings of light-emitting units in the peripheral area) can be adjusted based on the difference in luminance between the edge portion of the backlight module and the central area. For example, the light-emitting areas in the peripheral area referred to here are the outermost one or more concentrically arranged light-emitting areas in the array region. The meanings of the peripheral area and the central area of the array region are the same in the following embodiments, and repetitive descriptions will be omitted in subsequent descriptions.

For the sake of illustration, FIG. 2B and FIG. 3 only show the arrangement of light-emitting areas within the array region 101, omitting the depiction of the substrate 100 and the division of the peripheral area and central area for the array substrate. Additionally, FIG. 2B and FIG. 3 schematically depict the layout of light-emitting units. However, the division of the peripheral area and central area for the array region in FIG. 2B and FIG. 3 can refer to FIG. 2A and its related description. The light-emitting area 200 can include a plurality of first light-emitting areas 201 located in the peripheral area 1011 and a plurality of second light-emitting areas 202 located in the central area 1012. For example, the light-emitting areas 200 at the four edges of the array region are the first light-emitting areas 201. For instance, in the embodiment shown in FIG. 2B, the backlight module includes 38 first light-emitting areas 201 (the outermost ring of light-emitting areas), including 4 first light-emitting areas 201 located at the corner positions of the array region. The second light-emitting areas 202 are all light-emitting areas 200 outside the first light-emitting areas 201. Here, being located inside the first light-emitting areas 201 refers to being further away from the edges of the array region 101 compared to the first light-emitting areas 201.

For example, each first light-emitting area 201 and each second light-emitting area 202 include a plurality of light-emitting units 300. The black dots arranged in an array in FIG. 2B represent the light-emitting units. As shown in FIG. 2B, the number of light-emitting units 300 set in each second light-emitting area 202 is equal. For instance, the embodiment shown in FIG. 2B illustrates four light-emitting units 300 set in each second light-emitting area 202. However, these four light-emitting units are merely exemplary and can be adjusted to more or fewer units as needed. In FIG. 2B, for clarity, a light-emitting area 200 located at one corner of the upper right corner of the array region 101 is enlarged for display. The plurality of light-emitting units 300 in the plurality of first light-emitting areas 201 include a plurality of first light-emitting units 301 corresponding one-to-one with the plurality of light-emitting units 300 in the second light-emitting area 202. The center of each of the plurality of first light-emitting units 301 in the first light-emitting area 201 is located at each vertex of a first polygon 401, while the center of the light-emitting units 300 in the second light-emitting area 202 is located at each vertex of a second polygon 402. For clarity of illustration, FIG. 2B shows a first polygon 401 corresponding to a first light-emitting area 201 and a second polygon 402 corresponding to a second light-emitting area 202. It should be noted that the first polygon 401 and the second polygon 402 are merely illustrative for explaining the arrangement of light-emitting units and do not represent actual components. In the backlight module according to embodiments of the disclosure, the first polygon 401 and the second polygon 402 are similar polygons. It should be noted that similar polygons here include completely identical shapes, meaning that two polygons with the same shape and size are also within the scope of similar polygons. In the backlight module according to embodiments of the disclosure, the plurality of light-emitting units 300 in at least one first light-emitting area 201 among the plurality of first light-emitting areas 201 further include a second light-emitting unit 302. As shown in FIG. 2B, each first light-emitting area 201 at the four corners of the array region 101 also includes a second light-emitting unit 302 in addition to the first light-emitting units 301.

In the above embodiments, the first polygon and the second polygon are described using rectangles as examples, that is to say, each second light-emitting area includes four light-emitting units, and the arrangement is the same; each first light-emitting area includes four first light-emitting units, and the arrangement is the same. Here, “the arrangement is the same” refers to the relative positions of corresponding light-emitting units within their respective light-emitting areas being the same. However, embodiments of the disclosure are not limited to the first polygon and the second polygon being rectangles; they can also be other shapes, such as triangles, pentagons, hexagons, and so on. In these cases, the number of light-emitting units in the second light-emitting area and the number of first light-emitting units in the first light-emitting area vary accordingly.

Additionally, in this specification, when only “light-emitting unit” is mentioned, it can refer to either the first light-emitting unit or the second light-emitting unit, or both. Similarly, when only “light-emitting area” is mentioned, it can refer to either the first light-emitting area or the second light-emitting area, or both.

Although FIG. 2B shows that the four first light-emitting areas 201 located at the four corner positions include the second light-emitting unit 302, embodiments of the disclosure are not limited to this arrangement. It is also possible that one, two, or three of the light-emitting areas 201 at the corner positions have the second light-emitting unit 302. Alternatively, besides the light-emitting areas 201 at the corners, at least one first light-emitting area 201 located at any edge of the array region 101 may have the second light-emitting unit 302. In some other examples, none of the four first light-emitting areas 201 at the corner positions have the second light-emitting unit 302, but at least one first light-emitting area 201 located at any edge of the array region 101 has the second light-emitting unit 302. In some other examples, all four first light-emitting areas 201 at the corner positions have the second light-emitting unit 302, and four first light-emitting areas 201 located at the middle positions of the four edges of the array region 101 also have the second light-emitting unit 302.

As shown in FIG. 2B, in this embodiment, comparing the first light-emitting areas 201 having the second light-emitting unit 302 with the second light-emitting areas 202, the first light-emitting units 301 in these first light-emitting areas 201 correspond one-to-one with the light-emitting units in the second light-emitting areas 202, that is to say, the number of first light-emitting units 301 in these first light-emitting areas 201 is equal to the number of light-emitting units in the second light-emitting areas 202. However, these first light-emitting areas 201 further include a second light-emitting unit 302, so the number of light-emitting units in these first light-emitting areas 201 is greater than the number of light-emitting units in the second light-emitting areas. In this configuration, the brightness variation caused by halo effect in the peripheral region of the backlight module can be compensated or mitigated, thereby improving the uniformity of the backlight module's plane brightness and enhancing the display quality of the display device using the backlight module. Additionally, since the first polygon 401 and the second polygon 402 are similar shapes, the first light-emitting units 301 in the first light-emitting areas 201 are correspondingly set to the light-emitting units 300 in the second polygon 402. Consequently, the backlight module prevents excessive alteration of the wiring circuit or wiring pattern used to drive the light-emitting units in the peripheral region (area occupied by the first light-emitting areas) due to the addition of the second light-emitting unit 302. Thus, embodiments of the disclosure can improve the brightness uniformity issue in the peripheral light-emitting areas while remaining compatible with other designs. Moreover, in cases where the shapes and sizes of the first polygon 401 and the second polygon 402 are equal, the design of wiring circuits or wiring patterns in the peripheral and central regions can be further simplified.

For example, in the aforementioned plurality of light-emitting units 300 within the plurality of light-emitting areas 200, they can be connected in series, parallel, or a combination of both to simultaneously drive the plurality of light-emitting units 300 in each light-emitting area. Examples of the connection methods of the light-emitting units 300 in the first light-emitting areas 201 and the second light-emitting areas 202 will be described later in the disclosure.

For example, the aforementioned light-emitting units 300 may include packaged light-emitting diode (LED) chips, comprising LED chips and encapsulation structures. The LED chips can be sub-millimeter LED chips (mini-LEDs), with the size of the unpackaged LED chips in the direction perpendicular to the substrate 100 ranging from 70 micrometers to 180 micrometers, and the maximum size of the unpackaged LED chips in the direction parallel to the substrate 100 not exceeding 500 micrometers. For example, these LED chips can include Mini-LEDs (sized between 50 m and 300 μm) and Micro-LEDs (sized less than 50 μm). However, embodiments of the disclosure are not limited to this, and LED chips of any suitable size can be used. For example, inorganic LED chips can be used, which are LED chips made of inorganic materials, characterized by high brightness, high efficiency, and longer lifespan. Inorganic LEDs have higher brightness and better durability compared to traditional organic LEDs, providing better display performance. Additionally, inorganic LEDs have better environmental performance and do not pollute the environment. The manufacturing process of inorganic LEDs typically includes material preparation, chip manufacturing, and packaging steps. Manufacturing inorganic LEDs requires high-purity inorganic materials and high-precision manufacturing processes to ensure high brightness, high efficiency, and longer lifespan. For example, the light-emitting units used in the backlight module of the present disclosure can emit white light, for instance, using white LEDs. However, light-emitting units of other colors can also be used. In some embodiments, blue LEDs can be used as the light-emitting units 300, combined with a light-exciting material layer, such as a quantum dot material layer, located in the light-emitting layer 200. In this structure, the blue light emitted by the LED is incident on the light-exciting material layer, thereby exciting the active components (e.g., quantum dots) in the light-exciting material layer to emit various colors of light, which mix to form white light.

In the embodiment illustrated in FIG. 2B, the second light-emitting unit 302 is located inside the first polygon 401, and the first light-emitting area 201 having the second light-emitting unit 302 is provided with only one second light-emitting unit 302. However, embodiments of the disclosure are not limited to this configuration, and the second light-emitting unit 302 can also be positioned outside the first polygon. For example, FIG. 3 shows a schematic diagram of the planar structure of a backlight module according to other embodiments of the disclosure. To provide a clearer illustration, FIG. 3 enlarges one of the first light-emitting areas 201 located at a corner of the array region 101. The difference between the backlight module described in FIG. 3 and the backlight module shown in FIG. 2B lies in the position of the second light-emitting unit 302 in the first light-emitting area 201 provided with the second light-emitting unit 302. In the embodiment shown in FIG. 2B, the second light-emitting unit 302 is positioned inside the first polygon 401, while in the embodiment described in FIG. 3, the second light-emitting unit 302 is positioned outside the first polygon 401. For example, the second light-emitting unit 302 is positioned on one side of the plurality of first light-emitting units 301 in its corresponding light-emitting area 201, away from the second light-emitting area 202. In FIG. 3, there are three second light-emitting units 302 in the first light-emitting area 201 provided with the second light-emitting unit 302. However, embodiments of the disclosure are not limited to this, and one, two, or more second light-emitting units 302 can be positioned. Additionally, it should be noted that although in FIG. 3, the second light-emitting unit 302 is positioned outside the squares representing the light-emitting areas, the square structures are virtual square drawn for illustrative purposes only. The second light-emitting unit 302 located outside the corresponding square of the involved first light-emitting area is also considered as part of that first light-emitting area. As illustrated, a plurality of light-emitting units in the light-emitting areas are connected together in series/parallel to be simultaneously driven, as will be further understood in the following detailed description of individual light-emitting areas, making it clearer that the second light-emitting units 302 positioned outside the squares still belong to their respective first light-emitting areas.

The other parts of the embodiment shown in FIG. 3 can be the same as the embodiment shown in FIG. 2B. Therefore, the features of the embodiment shown in FIG. 2B, apart from the differences mentioned above, can be applied to the embodiment shown in FIG. 3, and are not reiterated here.

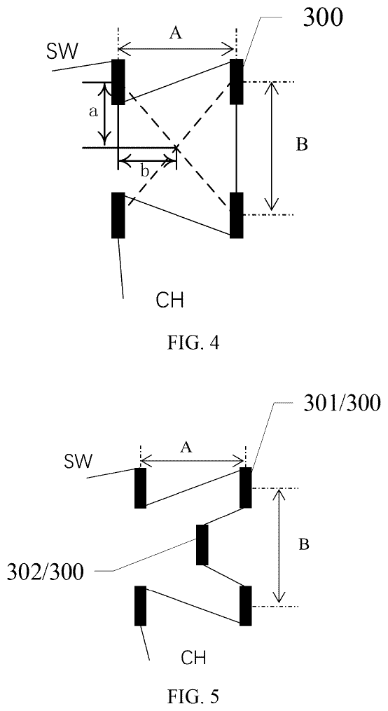

FIG. 4 illustrates a schematic diagram of the arrangement and connection of light-emitting units within a light-emitting area according to an embodiment of the disclosure. In FIG. 4, black bar-shaped elements represent the light-emitting units, and the line segments connecting the light-emitting units represent conductive wires. It should be noted that the conductive wires depicted here are merely to illustrate the connections between the light-emitting units and do not represent the specific shape or position of the conductive wires. A more detailed description of the wiring connecting the light-emitting units will be provided later. In FIG. 4, SW and CH represent two terminals used for wiring to drive the light-emitting units in this light-emitting area. Through terminals SW and CH, the driving power or signals can be transmitted to each light-emitting unit, allowing the light-emitting units to emit light in a controlled manner. The light-emitting area depicted in FIG. 4 can be the second light-emitting area of a backlight module according to an embodiment of the disclosure, for example, it can be applied in embodiments shown in FIG. 2B and FIG. 3 as the second light-emitting area 202. As shown in FIG. 4, the light-emitting area comprises four light-emitting units 300, with the centers of each light-emitting unit 300 positioned at the four corners of a virtual rectangle (not shown, refer to the second polygon 402 in FIG. 2B or FIG. 3). For example, the horizontal dimension of this virtual rectangle is denoted as A, and the vertical dimension as B. The relationship between dimensions A and B is not specifically limited and can be determined based on the horizontal and vertical dimensions of the array region and the number of light-emitting areas distributed horizontally and vertically. In some examples, the difference between dimensions A and B is less than 30% of dimension A, which helps ensure uniform mixing of light emitted by the various light-emitting units within the light-emitting area and further improves the overall brightness uniformity of the backlight module. As shown in FIG. 4, the four light-emitting units 300 are sequentially connected in series between terminals SW and CH, ensuring that the current passing through the plurality of light-emitting units within the same light-emitting area is consistent, thus resulting in substantially uniform light intensity emitted.

For each light-emitting area of the backlight module, the luminance is related to the distance between each light-emitting unit within the light-emitting area and the mixing distance. For example, the mixing distance is the distance between the light-emitting surface of the light-emitting unit and other optical layers (such as a diffusion plate), and it depends on the thickness of the material layer placed between the light-emitting unit and the optical layer. For instance, the material layer between the light-emitting unit and the optical layer may include lamp adhesive and/or light-exciting materials (such as a quantum dot layer). For example, the testing position for the luminance of the light-emitting area is fixed at the center of the light-emitting area, such as the position corresponding to the geometric center of the aforementioned first polygon or second polygon. During the design of the backlight module, to achieve a more regular light shape for each individual light-emitting area, it is required that the length and width of each individual light-emitting area be as close as possible. In other words, it is desirable for each individual light-emitting area to be as close to a square as possible, and it is required that the distance between adjacent light-emitting units be the same. For point sources of light, the intensity is inversely proportional to the distance. Assuming the brightness of the light-emitting unit is L0, the intensity at a distance equal to the mixing distance, denoted as L1, can be calculated as:

$$L 1 = n * \frac{L 0}{{a}^{2} + {b}^{2} + {h}^{2}}$$

wherein, a is ½ of the longitudinal dimension B shown in FIG. 4, b is ½ of the transverse dimension A shown in FIG. 4, h is the mixing distance, and n is the number of light-emitting units in the light-emitting area. The vertical dimension B and the horizontal dimension A are the two side lengths of the rectangle connecting the centers of the four light-emitting units.

For the first light-emitting area in the peripheral region of the array region, the brightness decrease caused by halo effect can be compensated by adding chips to enhance its brightness, thereby achieving a more uniform brightness distribution across the entire backlight module. Below is an illustrative calculation method for determining the number of compensatory light-emitting units based on brightness loss. For example, the brightness loss at the four corners of the array region is 50% (i.e., approximately 50% lower than the brightness of the second light-emitting area in the central region). In one example, the value of c for the light-emitting area (half the length of the diagonal of the rectangle mentioned above) is 1.54 mm, and the brightness at the center position when mixed to the bottom diffusion plate is L1=1.58*L0. To double L1, an additional light-emitting unit is required at the center position, and the mixing distance needs to be adjusted to 0.8 mm. This is just one way to calculate the number of additional second light-emitting unit 302 needed, but according to the embodiment of the disclosure, it is not limited to this. Other suitable methods can be used to determine the number of second light-emitting unit 302 to be added in the peripheral light-emitting areas. For example, the relationship between the number of additional second light-emitting unit and the increase in brightness can be determined through testing methods, thereby determining the number of second light-emitting unit in the peripheral light-emitting areas that need adjustment.

In the following examples, the arrangement and connection of light-emitting units in the first light-emitting area of the backlight module according to the embodiment of the disclosure will be described. It should be noted that the setting method of the first light-emitting area described below can be directly applied to the first light-emitting area 201 shown in FIG. 2B and FIG. 3. For example, the arrangement and connection method of the light-emitting units in the first light-emitting area shown in FIG. 2B or FIG. 3 can be set, modified, or replaced based on the arrangement and connection method of the light-emitting units described in the following examples.

FIG. 5 illustrates a schematic diagram of the arrangement and connection of light-emitting units in the light-emitting area according to an embodiment of the disclosure. In FIG. 5, in addition to the first light-emitting units 301 corresponding to the second light-emitting area, a second light-emitting unit 302 is further included. Since the arrangement of the first light-emitting units 301 is the same as that of the light-emitting units 300 in the second light-emitting area 202, reference can be made to the various features described in the example based on FIG. 2B without further elaboration. Here, the changes in layout and wiring methods after adding the second light-emitting unit 302 are detailed. The light-emitting area shown in FIG. 5 can be applied to the first light-emitting area of the backlight module according to the embodiment of the disclosure, for example, it can be applied to the first light-emitting area 201 shown in the embodiment of FIG. 2B.

As shown in FIG. 5, the second light-emitting unit 302 is located on the inner side of the first polygon (not shown, refer to the first polygon 401 shown in FIG. 2B), which is formed by connecting the centers of multiple first light-emitting units. The center of a light-emitting unit refers to the geometric center of the light-emitting unit's projection onto the plane parallel to the substrate 100. This definition applies to both the first light-emitting unit 301 and the second light-emitting unit 302. For example, the center of the second light-emitting unit 302 is located at the geometric center of the first polygon 401. In some other embodiments, the distance between the center of the second light-emitting unit 302 and the geometric center of the first polygon 401 can be set to less than one-fifth of the shortest side length of the first polygon.

For example, as shown in FIG. 5, the conductive wires connecting the second light-emitting unit 302 and multiple first light-emitting units 301, which are arranged in series on the substrate 100, are symmetrically distributed relative to a straight line passing through the center of the second light-emitting unit 302. For instance, this line extends in the horizontal direction in FIG. 5. The symmetrical distribution of the wires will be further illustrated in the example described with the wiring pattern later, making it clearer, and thus no detailed description is repeated herein. For instance, in the serial structure shown in FIG. 5, one side of the second light-emitting unit 302 includes two first light-emitting units 301, and the other side of the second light-emitting unit 302 also includes two first light-emitting units 301. In other words, in the serial circuit, the number of first light-emitting units 301 on each side of the second light-emitting unit 302 is equal.

For example, as illustrated in FIG. 5, the second light-emitting unit 302 has a strip shape extending along the first direction (longitudinal direction in the figure), and the mentioned straight line extends along the second direction (horizontal direction in the figure), which is perpendicular to the first direction and parallel to the substrate 100.

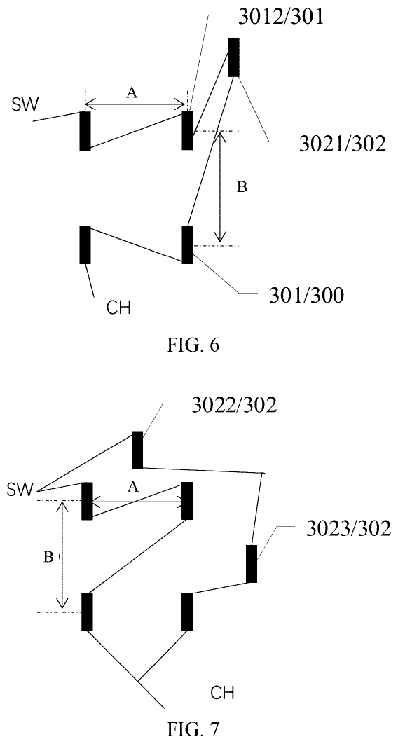

FIG. 6 illustrates a schematic diagram of the arrangement and connection of light-emitting units within a light-emitting area according to an embodiment of the disclosure. The structure shown in FIG. 6 differs from that shown in FIG. 5 in the position of the second light-emitting unit 302. Here, only this differing structure is described, while similar features can be described based on the description from FIG. 5 without repetition. As shown in FIG. 6, the second light-emitting unit is positioned on the outer side of the first polygon (not shown, please refer to FIG. 3). For instance, the second light-emitting unit 302 is located on the side of multiple first light-emitting units 301 away from the second light-emitting area 202. Combining the illustrations in FIG. 3 and FIG. 6, at least one first light-emitting area 201 with the second light-emitting unit 302 is positioned at the corner of the array region 101. The first light-emitting unit 301 within the first light-emitting area 201 includes a corner light-emitting unit 3012 closest to the corner position. The second light-emitting unit 302 comprises a first edge light-emitting unit 3021 located at a side of the corner light-emitting unit 3012 away from the center of the array region 101. By positioning the first edge light-emitting unit 3021 as described above, the brightness of multiple first light-emitting units 301 in the first light-emitting area 201 can be compensated for by the halo effect, thereby improving the brightness of the peripheral light-emitting area located in the array region. Additionally, by placing the first edge light-emitting unit 3021 on the outer side of the first polygon, the driving circuitry for the first light-emitting units corresponding to the light-emitting units in the second light-emitting area can be less modified, simplifying the manufacturing process.

As shown in FIG. 6, the first edge light-emitting unit 3021 is sequentially connected in series to the plurality of first light-emitting units 301. In this serial circuit, the first edge light-emitting unit 3021 is positioned between the plurality of first light-emitting units 301. In some examples, the number of first light-emitting units 301 on both sides of the first edge light-emitting unit 3021 in this serial circuit is the same.

For example, as illustrated in FIG. 6, the distance between the center of the first edge light-emitting unit 3021 in this first light-emitting area and the center of the corner light-emitting unit 3012 is less than the distance between the centers of any two adjacent first light-emitting units 301 in the first light-emitting area. This configuration reduces the additional space required for setting the first edge light-emitting unit 3021, facilitating narrow bezel designs. Moreover, such a setup can better compensate for the brightness of the first light-emitting area.

FIG. 7 illustrates a schematic diagram of the arrangement and connection of light-emitting units in a light-emitting area according to an embodiment of the disclosure. The structure shown in FIG. 7 differs from that shown in FIG. 6 in the position of the second light-emitting unit 302. Here, only this differing structure is described, while the same features can be described using the aforementioned description based on FIG. 6 and will not be repeated.

Referring to FIG. 3 and FIG. 7 in combination, the first polygon 401 (not shown in FIG. 7 for clarity) includes a first edge (e.g., the upper side in the figure) and a second edge (e.g., the right side in the figure) closest to the corner position of the array region 101, and one end of the first edge is connected to one end of the second edge, with the connecting point being the point on the first polygon closest to the corner position. The second light-emitting unit 302 includes a second edge light-emitting unit 3022 located on a side of the first edge away from the inside of the array region 101 and a third edge light-emitting unit 3023 located on a side of the second edge away from the inside of the array region 101. By setting up these two second light-emitting units, compensation for the luminance of the first light-emitting area can be achieved from different directions, thus achieving more uniform luminance.

For example, as shown in FIG. 7, the second edge light-emitting unit 3022 and the third edge light-emitting unit 3023 are connected in series with a first light-emitting unit 301 to form a first series circuit. The remaining first light-emitting units 301 are sequentially connected in series one after another to form a second series circuit. The ends of the first series circuit and the second series circuit are connected to each other to form a parallel circuit. In this embodiment, adding two light-emitting units in complete series may result in a large voltage difference between terminal SW and terminal CH. By using the series-parallel combined connection method according to this embodiment, a voltage division effect can be achieved.

For instance, as shown in FIG. 7, the number of light-emitting units in the aforementioned first series circuit is equal to that in the second series circuit. By setting the same number of light-emitting units in the series circuits, the luminous intensity emitted by each light-emitting unit can be made more uniform, which is beneficial for the overall brightness uniformity of the backlight module.

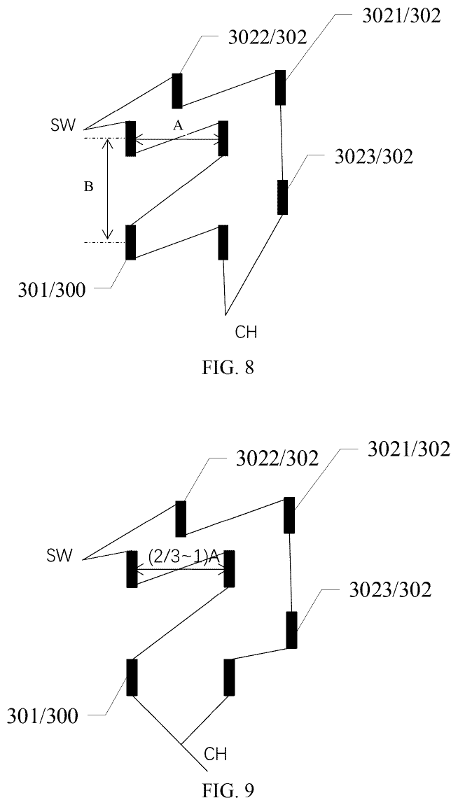

FIG. 8 illustrates a schematic diagram of the arrangement and connection of light-emitting units within a light-emitting area according to an embodiment of the disclosure. The structure shown in FIG. 8 differs from the structure shown in FIG. 7 in terms of the number and position of the second light-emitting unit 302. Only this differing structure will be described here, while the same features can be described using the descriptions based on FIG. 7 without repetition.

Referring to FIGS. 3 and 8, the first light-emitting area 201 is located at the corner of the array region 101. The first light-emitting unit 301 in the first light-emitting area 201 includes the corner light-emitting unit 3012 closest to the corner position. The second light-emitting unit 302 includes the first edge light-emitting unit 3021 located at a side of the corner light-emitting unit 3012 away from the center of the array region 101. The first polygon 401 includes the first side (e.g., the upper side in the figure) and the second side (e.g., the right side in the figure) closest to the corner position of the array region 101, and one end of the first side is connected to one end of the second side, where the connection point is the point closest to the corner position on the first polygon. The second light-emitting unit 302 further includes the second edge light-emitting unit 3022 located on a side of the first side away from the inside of the array region 101, and the third edge light-emitting unit 3023 located on a side of the second side away from the inside of the array region 101. Therefore, in the embodiment shown in FIG. 8, the number of second light-emitting units is greater than the number of second light-emitting units shown in FIG. 7. It can also be considered that the second light-emitting unit 3021 shown in FIG. 6 and the second light-emitting units 3022 and 3023 shown in FIG. 7 are all arranged in the same first light-emitting area. Therefore, the combined effect according to this embodiment can further enhance the luminous intensity at the edge position, especially at the corner position, thereby improving the brightness uniformity of the backlight module.

As shown in FIG. 8, the second edge light-emitting unit 3022, the first edge light-emitting unit 3021, and the third edge light-emitting unit 3023 are sequentially connected in series to form a first series circuit, and the plurality of first light-emitting units 301 are connected to each other in series to form a second series circuit. Both ends of the first series circuit and the second series circuit are connected to each other to form a parallel circuit. By using the series-parallel combination connection method, the voltage division effect described in FIG. 7 can also be achieved. Additionally, in the structure according to this embodiment, the second light-emitting unit 302 is in one separate series circuit. Furthermore, in the series circuits of multiple first light-emitting units, the connection method can also be slightly varied for ease of wiring. For example, compared to the series connection method in the second light-emitting area, the first light-emitting units at the top-left corner, top-right corner, bottom-left corner, and bottom-right corner can be connected in series sequentially to facilitate the wiring of the entire light-emitting area. In contrast, in the second light-emitting area, the first light-emitting units at the top-left corner, top-right corner, bottom-right corner, and bottom-left corner are connected in series sequentially in a clockwise direction.

FIG. 9 illustrates a schematic diagram of the arrangement and connection of light-emitting units within a light-emitting area according to an embodiment of the disclosure. The structure shown in FIG. 9 differs from that shown in FIG. 8 in the manner of series-parallel connection between the light-emitting units. This description focuses solely on this differing structure, while the same features can be described using the above description based on FIG. 8 without repetition.

As shown in FIG. 9, the second edge light-emitting unit 3022, the first edge light-emitting unit 3021, the third edge light-emitting unit 3023, and one of the first light-emitting units are sequentially connected in series to form a first series circuit. For example, the first light-emitting unit connected in series with the second light-emitting units is the one closest to the third edge light-emitting unit, excluding the corner light-emitting unit 3012. The remaining first light-emitting units are sequentially connected in series to form a second series circuit. The two ends of the first series circuit and the second series circuit are connected to each other to form a parallel circuit.

In the light-emitting area structures shown in FIG. 8 and FIG. 9, for instance, the centerline connecting the first edge light-emitting unit 3021 and the second edge light-emitting unit 3022 is parallel to the aforementioned first edge, and the distance from the center of the second edge light-emitting unit 3022 to the first edge is between ⅓ and \sqrt{3}/2 times the length of the first edge. This configuration ensures a better brightness compensation effect and a more uniform in-plane luminance for the first light-emitting area.

Similarly, in the light-emitting area structures shown in FIG. 8 and FIG. 9, the centerline connecting the first edge light-emitting unit 3021 and the third edge light-emitting unit 3023 is parallel to the aforementioned second edge, and the distance from the center of the third edge light-emitting unit 3023 to the second edge is between ⅓ and \sqrt{3}/2 times the length of the second edge. This configuration also enhances the brightness compensation effect and a more uniform in-plane luminance for the first light-emitting area.

In the light-emitting area structures depicted in FIG. 8 and FIG. 9, three additional second edge light-emitting units are added compared to the second light-emitting area. Consequently, the brightness around the first light-emitting area is higher. To achieve a more uniform brightness in this area, the ratio of the length of the first polygon 401 to the corresponding length of the second polygon 402 is set to be greater than or equal to ⅔ and less than 1. In this example, the length of the first polygon is less than the corresponding length of the second polygon. This configuration ensures a more uniform brightness for the first light-emitting area, especially at the corners located in the array region.

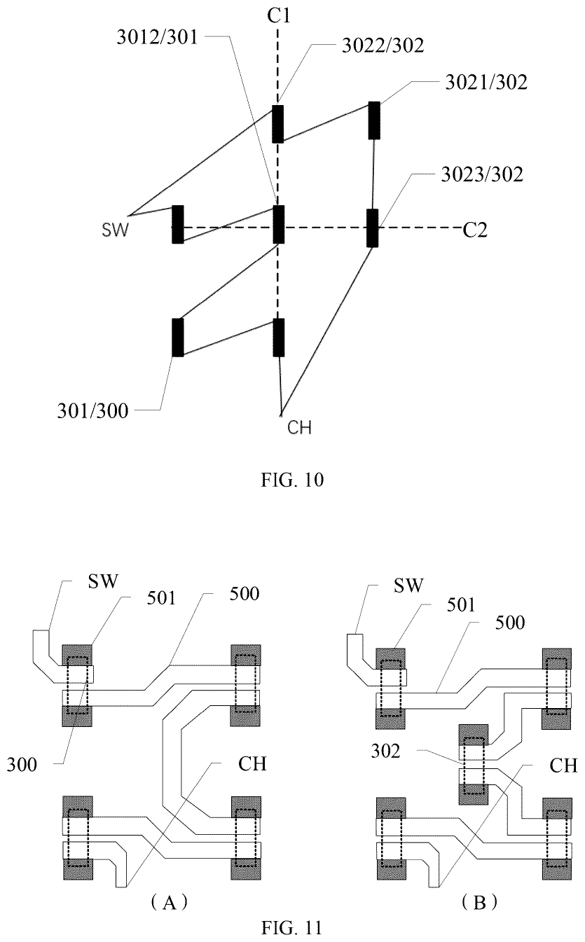

FIG. 10 illustrates a schematic diagram of the arrangement and connection of light-emitting units in a light-emitting area according to an embodiment of the disclosure. The structure shown in FIG. 10 differs from that shown in FIG. 8 in the positions of the second edge light-emitting unit and the third edge light-emitting unit. Here, only this differing structure is described, and for the same features, the description based on FIG. 10 can be used without repetition.

In the embodiment shown in FIG. 10, the light-emitting area further includes the first edge light-emitting unit 3021, the second edge light-emitting unit 3022, and the third edge light-emitting unit 3023. In the embodiments from FIG. 8 to FIG. 10, the orthographic projection of the second edge light-emitting unit 3022 on the line, on which the first side of the first polygon is located, overlaps with at least a portion of the first side. For example, in the embodiments shown in FIG. 8 and FIG. 9, the perpendicular bisector of the first side crosses the second edge light-emitting unit 3022. Additionally, in the embodiments from FIG. 8 to FIG. 10, the orthographic projection of the third edge light-emitting unit 3023 on the line, on which the second side of the first polygon is located, overlaps with at least a portion of the second side. For example, in the embodiments shown in FIG. 8 and FIG. 9, the perpendicular bisector of the second side crosses the third edge light-emitting unit 3023. Unlike FIG. 8, in the embodiment shown in FIG. 10, the second edge light-emitting unit 3022 is closer to the extension line C1 outside the array region of the second side, and the third edge light-emitting unit 3023 is closer to the extension line C2 outside the array region of the first side. For example, as shown in FIG. 10, the extension line C1 outside the array region of the second side crosses the second edge light-emitting unit 3022, and the extension line C2 outside the array region of the first side crosses the third edge light-emitting unit 3023.

In the embodiment shown in FIG. 10, the connection method between light-emitting units is the same as that in the embodiment shown in FIG. 8, but the embodiments of the disclosure is not limited thereto. The connection method between the light-emitting units in the embodiment shown in FIG. 10 can also adopt the connection method between the light-emitting units in the embodiment shown in FIG. 9, namely, three second light-emitting units 302 are serially connected to one first light-emitting unit 301 to form a serial circuit.

In the embodiment shown in FIG. 10, the distance between the center of the second edge light-emitting unit 3022 and the center of the corner light-emitting unit 3012 is less than or equal to the length B of the second side (refer to FIG. 8), and the distance between the center of the third edge light-emitting unit 3023 and the center of the corner light-emitting unit 3012 is less than or equal to the length A of the first side (refer to FIG. 8). Additionally, the distance relationship between the second edge light-emitting unit 3022 and the third edge light-emitting unit 3023 and the first polygon can also satisfy the relationship shown in FIG. 8. For example, the distance from the center of the second edge light-emitting unit 3022 to the first side is from ⅓ to \sqrt{3}/2 of the length of the first side; the distance from the center of the third edge light-emitting unit 3023 to the second side is from ⅓ to \sqrt{3}/2 of the length of the second side. This configuration can provide better brightness compensation for the first light-emitting area and more uniform in-plane luminance.

FIG. 11 illustrates a schematic diagram of a wiring structure for driving light-emitting units in some embodiments of the disclosure. FIG. 11(A) schematically illustrates the wiring structure for driving the second light-emitting area or the first light-emitting area without the second light-emitting units; FIG. 11(B) schematically illustrates the wiring structure for driving the light-emitting units in the first light-emitting area with the second light-emitting units. As shown in FIG. 11(A), the light-emitting area includes conductive wires 500 connecting the light-emitting units. For example, the conductive wires 500 may be formed by patterning a deposited conductive layer on a substrate, and the specific material and thickness of the conductive wire are not particularly limited in embodiments of the disclosure. In addition, solder pads 501 are also provided at positions for connecting the electrodes of the light-emitting units 300. For instance, the conductive wires 500 are connected to the electrodes of the light-emitting units via the solder pads. Consequently, the light-emitting units 300 are serially connected through the conductive wires and solder pads. When a driving power supply or driving signal is applied from terminals SW and CH, these light-emitting units 300 can be driven to emit light. Since the light-emitting units 300 in this light-emitting area are serially connected, they can be driven to emit light simultaneously. FIG. 11(B) is a schematic diagram of the wiring structure of the first light-emitting area according to embodiments of the disclosure, which is applicable when an additional second light-emitting unit is set inside the first polygon. It can be observed from the figure that, based on the wiring structure of the second light-emitting area, one end of the C-shaped conductor is interrupted and solder pads 501 are added, allowing the additional second light-emitting unit 302 to be serially connected to the circuit structure. If the wiring structure of the second light-emitting area is considered the original design and the wiring structure of the first light-emitting area is considered the modified design, the changes between them are relatively minor, thus allowing for adjustments to the number of light-emitting units in the first light-emitting area while maintaining compatibility with the original process.

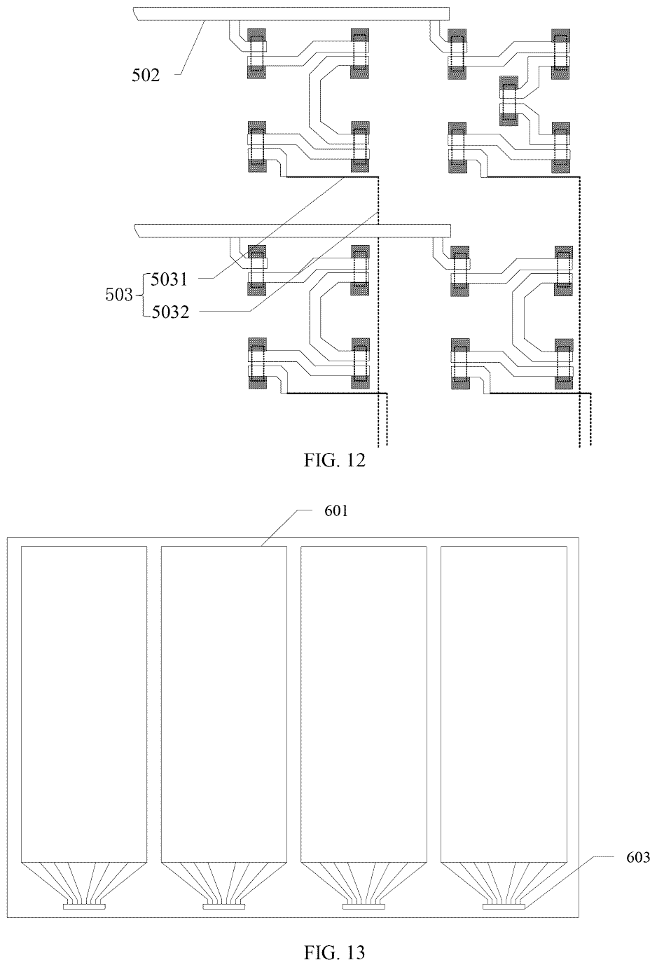

FIG. 12 illustrates a schematic diagram of a local wiring structure of a light-emitting area including a second light-emitting unit in a backlight module according to embodiments of the disclosure. FIG. 12 shows a first light-emitting area located in the upper right corner and three second light-emitting areas. For instance, terminals SW of the light-emitting areas in a row are connected to the same first power line 502. For example, the power line may also be referred to as a signal line. At least a part of the light-emitting units in a column may be connected to different second power lines 503, but embodiments of the disclosure are not limited to this, and independent light-emitting control can be achieved as long as different light-emitting units are not connected to completely identical first and second power lines. For example, the second power line may include a first portion 5031 and a second portion 5032. The first portion 5031 extends horizontally and may be in the same layer as the conductive wires for serially connecting the light-emitting units in the light-emitting area, while the second portion 5032 extends vertically and may be in a different layer from the first portion 5031, but they are electrically connected to each other.

FIG. 13 is a schematic diagram of the planar structure of a backlight module according to embodiments of the disclosure. For the plurality of light-emitting areas arranged in an array in the backlight module, driving can be performed in groups. For example, each group of light-emitting areas is connected to one or a set of drivers. For instance, in a backlight module according to embodiments of the disclosure, it may include a plurality of driving regions 601, and the light-emitting units within each driving region 601 are controlled for light emitting by a corresponding driver 603. For example, the driver 603 of the driving region 601 is located on one side of the array region, and the light-emitting areas within the driving region 601 are connected to the driver 603.

For example, FIG. 13 schematically illustrates four drive regions 601, but embodiments disclosed herein are not limited thereto. For instance, each driving region 601 corresponds to a driver 603, and the plurality of light-emitting areas located in the driving region 601 can be connected to the driver 603 via conductive wires through a fan-out region between the array region and the driver 601.

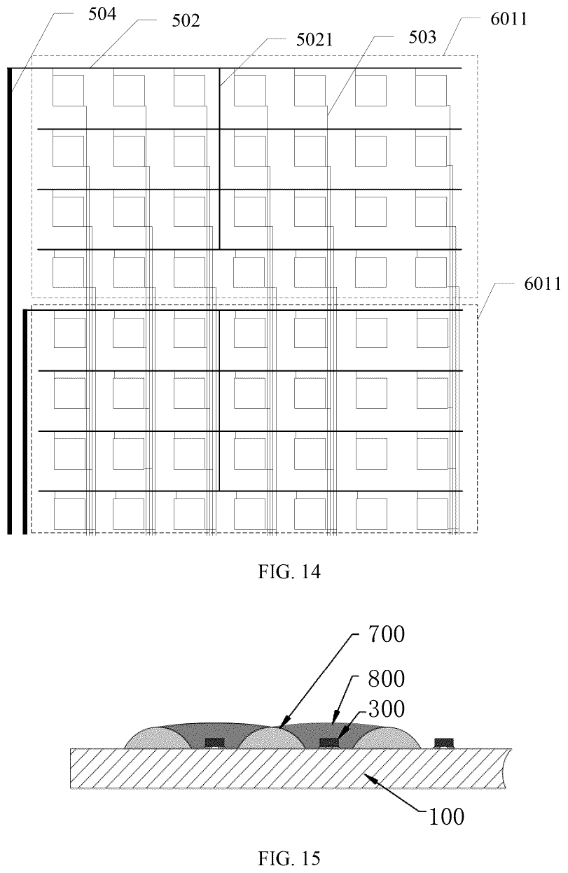

FIG. 14 illustrates a schematic diagram of a local planar structure of a backlight module according to embodiments of the disclosure. FIG. 14 shows only a local structure of a driving region 601. As shown in FIG. 14, each driving region 601 comprises a plurality of sub-driving regions 6011, with each sub-driving region 6011 containing a plurality of light-emitting areas 200 arranged along the row and column directions (simplified as squares in FIG. 14). For example, each sub-driving region 6011 in FIG. 14 is schematically shown to include four rows and seven columns of light-emitting areas, but this is merely exemplary, and embodiments of the disclosure are not limited thereto. For instance, the first terminals SW of the plurality of light-emitting areas in each sub-driving region 6011 are connected to the same first power line 502, while the first terminals SW of the plurality of light-emitting areas in different sub-driving regions 6011 are connected to different first power lines 502. For example, as shown in FIG. 14, the first power line 502 includes a plurality of horizontally extending conductive wires, with each horizontally extending conductive wire connected to a row of light-emitting areas within the sub-driving region 6011. The first power line 502 further includes vertically extending connecting conductive wires 5021, which electrically connect the plurality of horizontally extending conductors within the same sub-driving region 6011. Therefore, the first power line for connecting the first terminals SW in the plurality of light-emitting areas and being connected together within the same sub-driving region 6011 is referred to as the same first power line.

As shown in FIG. 14, the second terminals CH of the plurality of light-emitting areas 200 in the same sub-driving region 6011 are respectively connected to different second power lines 503. Light-emitting areas located in different sub-driving regions 6011 but in the same column comprise the light-emitting areas which are connected to the same second power line 503.

In some examples, in different sub-driving regions within the same driving region, the plurality of light-emitting areas in two sub-driving regions and in the same column are in a one-to-one correspondence. The second terminals of the corresponding light-emitting areas are connected to the same second power line. As shown in FIG. 14, in the leftmost column of light-emitting areas, in the column direction, the first one of the light-emitting areas 200 of the upper sub-driving region 6011 and the first one of the light-emitting areas 200 of the lower sub-driving region 6011 are connected to the same second power line 503; the second one of the light-emitting areas 200 of the upper sub-driving region 6011 and the second one of the light-emitting areas 200 of the lower sub-driving region 6011 are connected to the same second power line 503; the third one of the light-emitting areas 200 of the upper sub-driving region 6011 and the third one of the light-emitting areas 200 of the lower sub-driving region 6011 are connected to the same second power line 503; the fourth one of the light-emitting areas 200 of the upper sub-driving region 6011 and the fourth one of the light-emitting areas 200 of the lower sub-driving region 6011 are connected to the same second power line 503. The connection method for the light-emitting areas in other columns is similar and is not further described here. This configuration simplifies the wiring and enables independent driving of each light-emitting area.

Additionally, as shown in FIG. 14, the first power lines 502 in each sub-driving region 6011 are respectively connected to drivers via different power lines 504 (not shown in the figure).

FIG. 15 illustrates a schematic diagram of a partial cross-sectional structure of a backlight module according to an embodiment of the disclosure. As shown in FIG. 15, the light-emitting units 300 are connected to the substrate 100 via solder pads, thus being connected to the conductive wires on the substrate to receive driving signals or driving power. Surrounding the light-emitting units 300, a reflective structure 700 is provided. For instance, the reflective structure 700 includes white adhesive laid on the substrate 100. The white adhesive forms multiple groove structures, with the light-emitting units situated within these grooves. Consequently, the white adhesive surrounding the light-emitting units 300 can reflect the light emitted from the light-emitting units 300, directing it more concentratively upward. Furthermore, since the white adhesive forms a plurality of grooves arranged in an array corresponding to the plurality of light-emitting units, the white adhesive layer is structured as a grid, also referred to as a white adhesive grid. A transparent adhesive layer 800 can be provided within the grooves of the white adhesive and above the light-emitting units 300 to protect them.

The light-emitting units typically employ light-emitting diode chips. Since manufacturers of light-emitting units offer multiple brightness levels for products of the same specifications, distributing light-emitting units with different brightness levels in different areas can improve the uniformity of the backlight module's brightness. This approach primarily involves selecting high-brightness-level light-emitting units for arrangement to achieve brightness compensation. It mainly targets the light-emitting areas in the peripheral areas of the array region, especially the light-emitting areas at the corners, by selecting light-emitting units of appropriate brightness levels for arrangement to perform brightness compensation. For example, the highest brightness-level light-emitting units can be placed at the corner positions of the array region, the medium brightness-level light-emitting units can be placed for the light-emitting areas at the edge positions other than the corners of the array region, and the low brightness-level light-emitting units can be placed for the internal light-emitting areas. Therefore, an embodiment of the disclosure further provides a backlight module comprising: a substrate comprising an array region, wherein the array region is provided with a plurality of light-emitting areas arranged in an array, wherein the array region comprises a peripheral area and a central area located inside the peripheral area, and the plurality of light-emitting areas comprise a plurality of first light-emitting areas located in the peripheral area and a plurality of second light-emitting areas located in the central area, each of the first light-emitting areas and each of the second light-emitting areas comprising a plurality of light-emitting units, the number of light-emitting units provided in each of the first light-emitting areas and each of the second light-emitting areas is equal, and the arrangement is the same, under the condition of inputting the same power signal, the light intensity of the light-emitting units in at least one of the first light-emitting areas is greater than the light intensity of the light-emitting units in the second light-emitting areas. For example, the planar shape of the array region includes a polygon, and at least one of the first light-emitting areas is located at at least one corner of the array region. Through this scheme to improve the brightness of the peripheral area, costs are reduced as no changes to wiring design are needed. Additionally, this scheme can also be combined with the scheme of increasing the number of light-emitting units in the peripheral light-emitting areas mentioned above. For example, different brightness levels of light-emitting units can be arranged on the basis of the increased number of light-emitting units in different areas.

The above introduces a backlight module according to some embodiments of the disclosure, wherein the features of the above embodiments can be combined with each other. For example, the above first polygon and second polygon are shown as rectangles in the figures, but embodiments of the disclosure are not limited to this. For instance, the light-emitting units can be in the form of elongated strips extending along a first direction, where the first direction can be the extension direction of the long side of the rectangle, i.e., the first direction is parallel to the long side of the rectangle.

Furthermore, according to embodiments of the disclosure, a display device is provided, comprising a backlight module according to any one of the above embodiments. For example, the display device may be a liquid crystal display device comprising a liquid crystal display panel, with the backlight module positioned on one side of the liquid crystal display panel. Since the display device includes the backlight module according to any one of the above embodiments, it also has the technical benefits brought by the backlight module mentioned above, which is not repeated herein.

Currently, algorithms for white screen calibration typically result in consistent current and voltage across the backlight's light-emitting areas and uniform transmittance across the display panel, ultimately leading to lower measured brightness uniformity. According to embodiments of the disclosure, a method for driving a display device is provided. For example, the display device includes a backlight module and a liquid crystal display panel stacked upon each other, where the backlight module comprises an array region with independently driven light-emitting areas arranged in an array. The array region comprises a peripheral area and a central area inside the peripheral area. The plurality of light-emitting areas include a plurality of first light-emitting areas located in the peripheral area and a plurality of second light-emitting areas located in the central area. The liquid crystal display panel comprises a plurality of sub-display areas, the plurality of sub-display areas include a plurality of first sub-display areas which correspond one-to-one with the plurality of first light-emitting areas, and a plurality of second sub-display areas correspond one-to-one with the second light-emitting areas. The method comprises: driving the plurality of light-emitting areas to emit light and controlling the transmittance of the plurality of sub-display areas to display images. For example, the plurality of first light-emitting areas and the plurality of second light-emitting areas can be driven to emit light in a manner such that the ratio of the intensity of light emitted by at least one of the plurality of first light-emitting areas to the grayscale value to be displayed by the corresponding first sub-display area is greater than the ratio of the intensity of light emitted by the second light-emitting area to the grayscale value to be displayed by the corresponding second sub-display area; and/or, driving the plurality of first sub-display areas and the plurality of second sub-display areas for display such that the ratio of the transmittance of at least one of the first sub-display areas to the grayscale value to be displayed by the first sub-display area is greater than the ratio of the transmittance of the second sub-display area to the grayscale value to be displayed by the second sub-display area. Since the backlight module adopting HDR technology itself allows for independent control of a plurality of light-emitting areas, and different pixels on the display panel can also be independently controlled, the problem of darkening in peripheral areas can be addressed through changes in the driving method without altering the product's structure, thus saving costs.

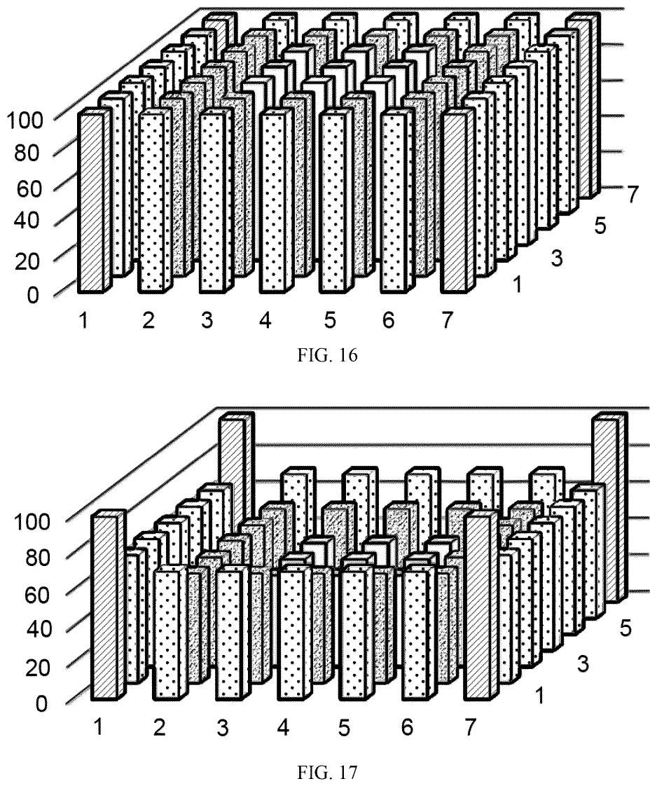

For example, FIG. 16 illustrates a schematic diagram of the driving signals without local dimming for peripheral and internal light-emitting areas; FIG. 17 illustrates a schematic diagram of the driving signals with local dimming for peripheral and internal light-emitting areas. Each cylinder in FIGS. 16 and 17 represents a light-emitting area, where the height of the cylinder represents the magnitude of the driving signal. For example, the magnitude of the driving signal may include the magnitude of the driving voltage or the driving current. For instance, in the case of displaying a white screen, FIG. 16 applies the same driving signal to each light-emitting area (please refer to the vertical axis in the figure); whereas in FIG. 17, the driving signal applied to the light-emitting areas at the corners is greater than the driving signal applied to the light-emitting areas at the edge positions except for the corners. The driving signal for the outermost layer (ring) of light-emitting areas is greater than the driving signal for the second outermost layer of light-emitting areas, and the driving signal for the second outermost layer of light-emitting areas is greater than the signal for the more internal light-emitting areas. The distribution shown in FIG. 17 is exemplary, and it may not be necessary to adjust the magnitude of the driving signal for multi-layer light-emitting areas step by step. Therefore, it is possible to enhance the driving signal only for the outermost layer or the corners of the light-emitting areas.

For example, the driving method of this embodiment mainly involves different processing and control of the algorithms for the backlight's various light-emitting areas through local dimming algorithms, with the main differences occurring in the positions of the outermost three layers of light-emitting areas. For instance, the brightness adjustment at the four corner positions is set to twice that of the central area (excluding the central part of the outer three rings of areas), and the brightness adjustment for the four edge positions of the outermost areas is set to 1.3-1.4 times that of the central area (about 25% lower brightness than the central area). The brightness gradually decreases from the edge areas to the central area (only the outer three layers are differently configured), with the brightness algorithm being consistent from the fourth layer of areas to the central area.

For instance, according to the local dimming algorithm for the backlight, the output signal is controlled by the driver. For example, the partition control mentioned above is mainly achieved through the driver's driving power consumption, and the power consumption variation is realized through the duty cycle of the driving signal (e.g., current).

For example, when different sub-display areas of the display panel are intended to display the same grayscale value, the transparency of the first sub-display area can be made greater than that of the second sub-display area to alleviate the problem of darkening in the periphery during display. Since each sub-pixel of the display panel can be independently controlled, including sub-display areas including multiple sub-pixels can also be independently controlled. This driving method does not incur additional costs while addressing the problem of darkening in the periphery. Additionally, this method is not limited to situations where the same grayscale value is intended to be displayed. For instance, when different grayscale values are present throughout the displayed image, setting the ratio of the transparency of at least one first sub-display area among the plurality of first sub-display areas to the greyscale value to be displayed by the first sub-display area to be greater than the ratio of the transparency of the second sub-display area to the greyscale vale to be displayed by the second sub-display area, can also achieve similar technical effects.

Here are some points to be noted:
(1) In the accompanying drawings of the disclosure, only the structures relevant to the embodiments disclosed herein are depicted. Other structures can be referenced as per common design.
(2) In cases where there are no conflicts, the features of the same embodiment or different embodiments disclosed herein can be combined with each other.

The above are specific embodiments of this disclosure, but the scope of protection of this disclosure is not limited thereto. Those skilled in the art familiar with the technology field to which this disclosure pertains can easily conceive variations or substitutions within the technical scope disclosed herein, all of which should be encompassed within the scope of protection of this disclosure. Therefore, the scope of protection of this disclosure should be determined by the protection scope of the claims.

1. A backlight module comprising:
a substrate including an array region in which a plurality of light-emitting areas are arranged in an array, wherein
the array region comprises a peripheral area and a central area located inside the peripheral area, the plurality of light-emitting areas comprise a plurality of first light-emitting areas located in the peripheral area and a plurality of second light-emitting areas located in the central area, each of the first light-emitting areas and each of the second light-emitting areas comprise a plurality of light-emitting units,
numbers of the light-emitting units in at least two second light-emitting areas of the plurality of second light-emitting areas are equal,
the plurality of light-emitting units in each of the first light-emitting areas comprise a plurality of first light-emitting units corresponding one-to-one with the plurality of light-emitting units in each of the at least two second light-emitting areas, centers of the plurality of first light-emitting units in each of the first light-emitting areas are located at respective vertices of a first polygon, and centers of the plurality of light-emitting units in each of the at least two second light-emitting areas are located at respective vertices of a second polygon, the first polygon and the second polygon are similar polygons, and
the plurality of light-emitting units of at least one of the plurality of first light-emitting areas further include a second light-emitting unit.

2. The backlight module according to claim 1, wherein
dimensions and a shape of the first polygon are identical to those of the second polygon, or a side length of the first polygon is less than a corresponding side length of the second polygon.

3. (canceled)

4. The backlight module according to claim 1, wherein the second light-emitting unit is located inside the first polygon.

5. The backlight module according to claim 4, wherein a distance between a center of the second light-emitting unit and a geometric center of the first polygon is less than one-fifth of a shortest side length of the first polygon.

6. The backlight module according to claim 5, wherein the center of the second light-emitting unit is located at the geometric center of the first polygon.

7. The backlight module according to claim 4, wherein the second light-emitting unit is serially connected to the plurality of first light-emitting units.

8. The backlight module according to claim 7, further comprising: conductive wires located on the substrate and serially connecting the second light-emitting unit and the plurality of first light-emitting units, wherein the conductive wires are symmetrically distributed relative to a straight line passing through a center of the second light-emitting unit,
the second light-emitting unit has a strip shape extending along a first direction parallel to the substrate, and the straight line extends along a second direction perpendicular to the first direction and parallel to the substrate.

9. (canceled)

10. The backlight module according to claim 1, wherein the second light-emitting unit is located outside the first polygon.

11. The backlight module according to claim 10, wherein the second light-emitting unit is located on a side of the plurality of first light-emitting units away from the second light-emitting areas,
at least one of the plurality of first light-emitting areas having the second light-emitting unit is located at a corner position of the array region, wherein the plurality of first light-emitting units in the first light-emitting area comprise a corner light-emitting unit closest to the corner position, and the second light-emitting unit comprises a first edge light-emitting unit located at a side of the corner light-emitting unit away from a center of the array region.

12. (canceled)

13. The backlight module according to claim 11,
wherein the first edge light-emitting unit is serially connected to the plurality of first light-emitting units, and in a serial circuit of the first edge light-emitting unit and the plurality of first light-emitting units, the first edge light-emitting unit is positioned between the plurality of first light-emitting units,
numbers of first light-emitting units on each side of the first edge light-emitting unit in the serial circuit are equal.

14. (canceled)

15. The backlight module according to claim 11, wherein a distance between a center of the first edge light-emitting unit and a center of the corner light-emitting unit in the first light-emitting area is less than a distance between centers of any two adjacent first light-emitting units in the first light-emitting area.

16. The backlight module according to claim 10, wherein the first polygon includes a first side and a second side closest to a corner position of the array region, and an end of the first side is connected to an end of the second side, the second light-emitting unit comprise a second edge light-emitting unit located on a side of the first side away from the inside of the array region and a third edge light-emitting unit located on a side of the second side away from the inside of the array region,
the second edge light-emitting unit and the third edge light-emitting unit are serially connected to one first light-emitting unit of the first light-emitting units to form a first serial circuit, and the one first light-emitting unit serially connected to the second light-emitting units is the first light-emitting unit closest to the third edge light-emitting unit except for the corner light-emitting unit, the remaining first light-emitting units in the plurality of first light-emitting areas are sequentially connected in series to form a second serial circuit, and both ends of the first serial circuit and the second serial circuit are connected to each other to form a parallel circuit,
the numbers of light-emitting units in the first serial circuit and the second serial circuit are equal.

17-18. (canceled)

19. The backlight module according to claim 10, wherein the first light-emitting area is located at a corner position of the array region, and the first light-emitting units in the first light-emitting area includes a corner light-emitting unit closest to the corner position of the array region, the second light-emitting unit includes a first edge light-emitting unit located at a side of the corner light-emitting unit away from the center of the array region, the first polygon includes a first side and a second side closest to the corner position of the array region, and an end of the first side is connected to an end of the second side, and the second light-emitting unit includes a second edge light-emitting unit located on a side of the first side away from the inside of the array region and a third edge light-emitting unit located on a side of the second side away from the inside of the array region,
the second edge light-emitting unit, the first edge light-emitting unit, and the third edge light-emitting unit are sequentially connected in series to form a first series circuit, and the plurality of first light-emitting units are connected in series to form a second series circuit, and both ends of the first series circuit and the second series circuit are connected to each other to form a parallel circuit: or, the second edge light-emitting unit, the first edge light-emitting unit, the third edge light-emitting unit, and one first light-emitting unit of the first light-emitting units are sequentially connected in series to form a first series circuit, and the one first light-emitting units connected in series with the plurality of second light-emitting units is one first light-emitting unit closest to the third edge light-emitting unit except for the corner light-emitting unit, and the remaining first light-emitting units in the plurality of first light-emitting units are sequentially connected in series to form a second series circuit, and both ends of the first series circuit and the second series circuit are connected to each other to form a parallel circuit.

20-21. (canceled)

22. The backlight module according to claim 19, wherein a line connecting centers of the first edge light-emitting unit and the second edge light-emitting unit is parallel to the first side, and a distance from the center of the second edge light-emitting unit to the first side is from ⅓ to \sqrt{3}/2 of a length of the first side,
a line connecting centers of the first edge light-emitting unit and the third edge light-emitting unit is parallel to the second side, and a distance from the center of the third edge light-emitting unit to the second side is from ⅓ to \sqrt{3}/2 of a length of the second side,
a ratio of a side length of the first polygon to a corresponding side length of the second polygon is greater than or equal to ⅔ and less than 1.

23-24. (canceled)

25. The backlight module according to claim 19, wherein an orthographic projection of the second edge light-emitting unit on a straight line where the first side of the first polygon is located overlaps with at least a portion of the first side, and an orthographic projection of the third edge light-emitting unit on a straight line where the second side of the first polygon is located overlaps with at least a portion of the second side,
a perpendicular bisector of the first side passes through the second edge light-emitting unit, and a perpendicular bisector of the second side passes through the third edge light-emitting unit; or, an extension line of the second side towards the outside of the array region passes through the second edge light-emitting unit, and an extension line of the first side towards the outside of the array region passes through the third edge light-emitting unit.

26-27. (canceled)

28. The backlight module according to claim 1, wherein the first polygon and the second polygon both have a rectangular shape,
the plurality of light-emitting units are all strip-shaped and extend along a first direction, wherein the first direction is parallel to the long side of the rectangular shape.

29. (canceled)

30. The backlight module according to claim 1, wherein each light-emitting area includes a first terminal and a second terminal to provide a driving power supply to the plurality of light-emitting units in the light-emitting area, and each light-emitting area is configured to be independently driven,
the array region includes a plurality of driving regions, and the light-emitting areas in each driving region are connected to a driver located on a side of the array region,
each driving region includes a plurality of sub-driving regions, each sub-driving region includes a plurality of light-emitting areas arranged along a row direction and a column direction, and the first terminals of the plurality of light-emitting units in each sub-driving region are connected to a same first power line, and the first terminals of the plurality of light-emitting units in different sub-driving regions are connected to different first power lines,
the second terminals of the plurality of light-emitting units in the same sub-driving region are respectively connected to different second power lines, and the light-emitting areas located in different sub-driving regions and in the same column comprise the light-emitting areas connected to a same second power line,
in different sub-driving regions of the same driving region, the light-emitting areas in two sub-driving regions and in the same column correspond one-to-one with each other, and the second terminals of the light-emitting areas corresponding with each other are connected to the same second power line.

31-35. (canceled)

36. A backlight module comprising: a substrate including an array region, the array region including a plurality of light-emitting areas arranged in an array, wherein
the array region includes a peripheral area and a central area located inside the peripheral area, and the plurality of light-emitting areas include a plurality of first light-emitting areas located in the peripheral area and a plurality of second light-emitting areas located in the central area, and each first light-emitting area and each second light-emitting area include a plurality of light-emitting units,
each first light-emitting area and each second light-emitting area have the same number and arrangement of light-emitting units,
in a case where a same power signal is input, light intensity of the light-emitting units in at least one first light-emitting area of the first light-emitting areas is greater than that of the light-emitting units in the second light-emitting area.

37. (canceled)

38. A display device comprising a backlight module according to claim 1.

39. A driving method for a display device, wherein the display device comprises a backlight module and a liquid crystal display panel stacked on each other, wherein the backlight module comprises an array region, and the array region includes a plurality of light-emitting areas independently driven and arranged in an array, the array region includes a peripheral area and a central area located inside the peripheral area, and the plurality of light-emitting areas include a plurality of first light-emitting areas located in the peripheral area and a plurality of second light-emitting areas located in the central region, and the liquid crystal display panel comprises a plurality of sub-display areas, the sub-display areas include a plurality of first sub-display areas corresponding one-to-one with the plurality of first light-emitting areas and a plurality of second sub-display areas corresponding one-to-one with the plurality of second light-emitting areas, the method comprises:
driving the plurality of light-emitting areas to emit light and driving transmittance of the plurality of sub-display areas to display images, wherein
the plurality of first light-emitting areas and the plurality of second light-emitting areas are driven to emit light such that a ratio of light intensity emitted by at least one first light-emitting area in the plurality of first light-emitting areas to a grayscale value to be displayed by a corresponding first sub-display area is greater than a ratio of light intensity emitted by the second light-emitting area to a grayscale value to be displayed by a corresponding second sub-display area; and/or
the plurality of first sub-display areas and the plurality of second sub-display areas are driven to display such that a ratio of transmittance of at least one first sub-display area in the plurality of first sub-display areas to a grayscale value to be displayed by the first sub-display area is greater than a ratio of transmittance of the second sub-display area to a grayscale value to be displayed by the second sub-display area.
